(19) United States
(12) Patent Application Publication
(10) Pub. No.: US 2025/0287181 A1
(43) Pub. Date: Sep. 11, 2025

(54) DYNAMICALLY ADAPTIVE MEDIA CONTENT DELIVERY

(71) Applicant: Snap Inc., Santa Monica, CA (US)

(72) Inventors: Aaron Son, Los Angeles, CA (US); Brian Hendriks, Pacific Palisades, CA (US)

(21) Appl. No.: 19/217,760

(22) Filed: May 23, 2025

Related U.S. Application Data
(63) Continuation of application No. 17/301,200, filed on Mar. 29, 2021, now Pat. No. 12,317,150.
Application No. 17/301,200 is a continuation of application No. 14/801,206, filed on Jul. 16, 2015, now Pat. No. 10,993,069.

(51) Int. Cl. H04W 4/021; H04L 65/1063; H04L 65/612; H04L 65/75; H04L 65/80; H04L 67/50; H04W 4/18

(52) U.S. Cl. CPC H04W 4/021; H04L 65/1063; H04L 65/612; H04L 65/762; H04L 65/80; H04L 67/535; H04W 4/18

(57) ABSTRACT

Media content delivery method and systems are provided for transmitting media content to a mobile client device in a format automatically selected from alternative versions of the media content based on one or more dynamically variable resource parameters. The variable resource parameters can include historical device and/or network performance corresponding to one or more current attributes applicable to a request for media content delivery from the mobile client device, such as a current location of the device and/or a time value for the requested media content delivery. Similar media content can thus be delivered to similar mobile client device in different formats depending on, say, the time and location of respective requests for receiving the media content.

### CLAIM OF PRIORITY

This application is a continuation of U.S. patent application Ser. No. 17/301,200, filed on Mar. 29, 2021, which is a continuation of U.S. patent application Ser. No. 14/801,206, filed on Jul. 16, 2015, each of which is incorporated herein by reference in its entirety.

### TECHNICAL FIELD

Embodiments of the present disclosure relate generally to data processing, data transmission techniques, and, more particularly, but not by way of limitation, to methods and systems for delivering media content to client computer devices.

### BACKGROUND

User consumption of media content (such as video, image, and/or audio content) on mobile electronic devices has become increasingly prevalent. Media download responsiveness and quality on mobile devices can, however, often be unreliable due to variability in resource availability or performance.

Different mobile networks, for example, can display differing levels of performance, while the performance of a particular network can vary significantly depending, e.g., on the time of day and/or the physical location of the mobile device.

### BRIEF DESCRIPTION OF THE DRAWINGS

Some aspects of the disclosure are illustrated in the appended drawings. Note that the appended drawings illustrate example embodiments of the present disclosure and cannot be considered as limiting the scope of the disclosure.

FIG. 1 is a schematic view of a mobile client device displaying a graphical user interface for requesting delivery of media content via a client application executing on the device, according to some embodiments.

FIG. 2 is a block diagram illustrating a networked system configured to provide some media content delivery functionalities, according to some example embodiments.

FIG. 3 is a schematic block diagram illustrating various hardware-implemented modules of a media content delivery system, according to some example embodiments.

FIG. 4 is a high-level flow diagram of a media content delivery method, according to some example embodiments.

FIG. 5 is a more detailed flow diagram of a method for automated media content delivery optimization, according to some example embodiments.

FIG. 6 is a block diagram illustrating an example of a software architecture that may be installed on a machine, according to some example embodiments.

FIG. 7 illustrates a diagrammatic representation of a machine in the form of a computer system within which a set of instructions may be executed for causing the machine to perform any one or more of the methodologies discussed herein, according to an example embodiment.

The headings provided herein are merely for convenience and do not necessarily affect the scope or meaning of the terms used.

### OVERVIEW

One aspect of the disclosure includes a media content delivery method that comprises transmitting a media content file to a mobile client device in a format automatically selected from alternative versions of the media content file based on one or more dynamically variable resource parameters. The variable resource parameters may be variable performance characteristics applicable to delivery of media content to the mobile device and/or to reproduction of media content on the mobile client device.

For example, a media content delivery system can be configured to identify that data transmission performance of a particular network connection over which the media content file is to be delivered has historically been relatively poor at the relevant time of day and, in response, select or deliver a version of a requested video file which is relatively smaller than other available versions (e.g., by employing more compact compression) and which thus places lesser demands on network bandwidth. The same video content may, in other instances, be transmitted to another device (or to the same device at a different time of day or over a different network) in a less compressed version of the video file, based on identification of better historical network performance applicable to that instance.

One version of a particular media content file (such as a file representing, for example, one or more digital images, one or more digital video clips, one or more animation sequences, one or more audio clips or audio book chapters, or the like) may thus be transmitted to some mobile client devices in one format, while an alternative version of the media content file, carrying the same media content, may be transmitted to another mobile client device, the particular version of the media content file to be delivered to the respective mobile client devices being automatically determined based on respective values for the one or more variable resource parameters that apply to the specific delivery event.

Downloading or delivery of media content files, in which media content carried by the file is reproducible only subsequent to completed file download, is to be distinguished from media streaming, in which the media content is reproducible while download is in progress. This is because applicable resource parameters and performance of streaming media delivery can be determined during the streaming delivery, in response to which characteristics of the streaming media can be changed during download. In contrast, download of discrete media content items or media content files demands finalization of content delivery format or configuration before delivery of an individual item or file is started.

Some embodiments include making available for delivery two or more alternative versions of the media content file, the alternative versions having different respective content delivery resource costs for delivery of the media content file to the mobile device and/or for reproducing or presenting the media content of the file on the mobile client device. Resource costs for delivery of the media content file may comprise compression costs (e.g., including server resource costs or processing costs for file compression to prepare the file for transmission), and/or transmission costs (e.g., including network bandwidth consumed in file transmission over the data network). For example, different file versions for common media content may have different bandwidth costs/demands. Instead, or in combination, the different file versions may have different on-device processing costs/demands for reproducing the media content on the mobile client device.

For example, a particular video clip may be made available for delivery in two different versions having been compressed using different compression formats with different respective compression ratios. A more compressed version of the file may, in such an example, consume greater server resources for compressing the video file, may consume lower transmission bandwidth due to transmission of a smaller version of the file, and may consume greater on-device processing resources for decompression. The system may automatically select for delivery an appropriate or optimal one of these two file versions based on the respective content delivery resource costs considered in combination with available server resources, network resources, and client device resources.

In some embodiments, the one or more variable resource parameters may be indicative of or associated with variable resource availability for file pre-processing (e.g., to prepare the file for transmission by file compression or the like), for file transmission, and/or for on-device media reproduction. The method may, in such cases, include selecting the specific version of the requested media content for delivery to the mobile device based, at least in part, on the available mobile device resources indicated by the one or more variable resource parameters and/or based, at least in part, on server resources available for file compression. For example, an application executing on the mobile client device may inform the server of available processing capacity of the client device and, in response to identifying that the available processing capacity is relatively limited or suboptimal for efficient media reproduction, the system may automatically select for delivery a version of the relevant media content file that places lower processing costs on the mobile client device for reproducing the requested media carried by the media content file.

A set of media content files that are to be delivered in association with one another or in a particular replay sequence (e.g., a set of associated photographs in a slideshow or a set of associated video clips) are in some embodiments available for delivery in different versions, with the different versions having different respective media reproduction properties or replay properties. In such embodiments, automated selection of a particular version of the set (or of at least some of the files in the set) may be based at least in part on the different media reproduction properties of the different alternative versions of the set. The media reproduction property of a set of media content files may, for example, include whether or not the set is capable of progressive reproduction, in which the media content of at least some files in the set can be reproduced on the mobile client device before download of the full set is completed. For example, a set of media content files comprising a stack of digital images may, in some embodiments, be available for delivery in one or more versions in which some of the pictures are viewable on the target device while other pictures in the stack are still in the process of downloading. One or more other versions of the same set of media content files may demand complete download of the whole stack of pictures before any of the pictures in the stack are available for viewing on the target device. In such cases, the method may include automatically selecting file versions and/or a version of the set that supports progressive reproduction in response to estimating that relatively poor data transmission resources and/or relatively limited on-device processing resources are expected to be available.

In some embodiments, the one or more variable resource parameters include an estimated resource performance value applicable to consumption of requested media content by the mobile client device. The estimated resource performance value can comprise an estimated value for substantially current or future resource performance based, at least in part, on historical resource performance data. Media content delivery can thus, in some embodiments, include calculating, e.g., an estimated applicable network transmission performance and/or an estimated applicable data processing performance of the mobile device, and then selecting one of a plurality of different versions of the media content file based on the estimated resource performance value values. In such cases, the one or more variable resource parameters may be determined based, at least in part, on historical performance data of the relevant resource(s) corresponding to one or more current attributes applicable to consumption of the requested media content by the mobile device.

For example, in response to a request for media content from a mobile device using AT&T cellular service over lunch time in December, the system may automatically identify that, historically, AT&T cellular data service at the particular current location of the mobile device is relatively poor in winter, and may, in response, automatically choose to transmit to the mobile device lower quality media content assets than would otherwise have been the case. This is to facilitate acceptable download speed and quality over the predicted lower-quality network connection. In some instances, the estimated resource performance value may be a predicted future resource performance value calculated with respect to expected future device attributes applicable to delivery and/or presentation of the requested media content at a particular future time.

It can thus be seen that, in some embodiments, the one or more current attributes include a current network of the mobile device, being a particular data network, such as a cellular network, to which the mobile device is currently connected and via which the requested media content is to be delivered. In such cases, the one or more variable resource parameters may include historical performance (e.g., historical data reception performance) of the mobile device when connected to the current network. Instead, or in addition, the one or more variable resource parameters may include historical performance of other mobile devices when connected to the current data network.

Instead, or in addition, the one or more current attributes may include a current physical location of the mobile device. In such cases, the one or more variable resource parameters may include historical performance of the mobile device when in substantially the same physical location, when in a physical location similar to the current physical location, or when within a geographical area corresponding to the current physical location. Instead, or in addition, the one or more variable resource parameters may include historical performance of other mobile devices when in substantially the same location, when in a physical location similar to the current physical location, or when within a geographical area corresponding to the current physical location.

Instead, or in addition, the one or more current attributes may include a current time value, for example comprising the current time of day, the current time of the week, the current time of the month, and/or the current time of the year. In such cases, the one or more variable resource parameters may include historical performance of the mobile device corresponding substantially to the current time value, and/or historical performance of other mobile devices at the current time value.

In some embodiments, the one or more variable resource parameters include one or more current wireless connection characteristics of the mobile device. The current wireless connection characteristics may include, in isolation or in combination, one or more measured values including: a current Wi-Fi channel, power ratio (dBm), a current interference measurement, a current cellular tower, current signal strength, and recent tower migration history.

Instead, or in combination, the one or more variable resource parameters taken into account for automated delivery version selection may, in some embodiments, include a recent change or delta in client activity volume from the same network and/or physical location from which a request for media content delivery is received. For example, the system is, in some embodiments, configured to select the appropriate file version for delivery in response to a request from a particular mobile device based, at least in part, on a recent delta in media content request volume from users sharing the same network and/or physical location.

The method may, in such cases, comprise selecting lower quality media assets for delivery to client devices on the network and/or at the physical location associated with a recent spike or above-threshold delta in media request volume. For example, requests for media content from mobile client devices of users at a well-attended event (such as a sports game, a concert, or the like) may display a significant increase or spike in volume during the game. A media content delivery system consistent with the disclosure may, for example, notice a large delta in media content request volume corresponding to the start of a football game at Qwest Field, in response to which file versions having relatively lower transmission costs/demands are automatically selected for delivery in response to the respective media content requests originating from a geofence region including Qwest Field. In contrast, a subsequent negative request volume delta (corresponding, e.g., to completion of the game) may automatically result in subsequent selection of relatively higher quality versions and/or delivery formats of the requested media content.

### DETAILED DESCRIPTION

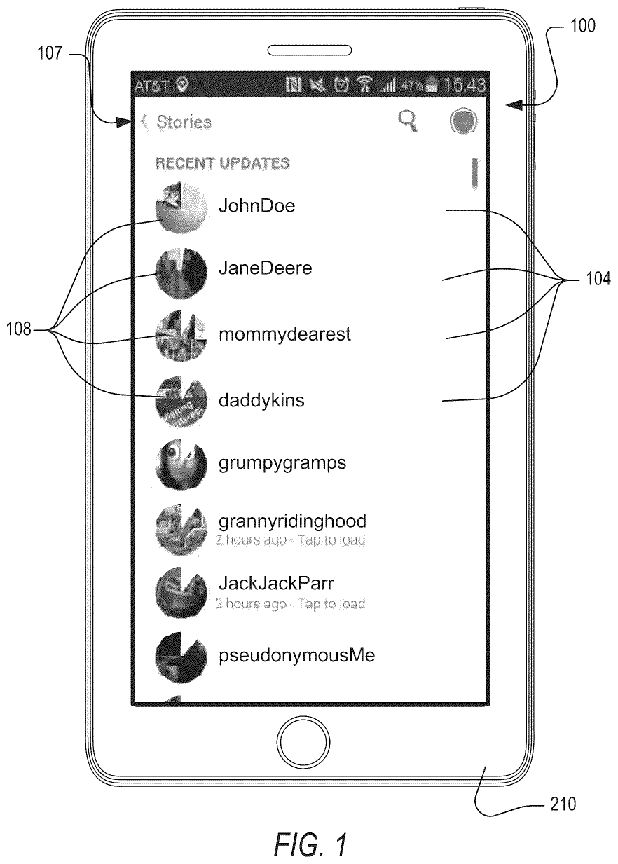

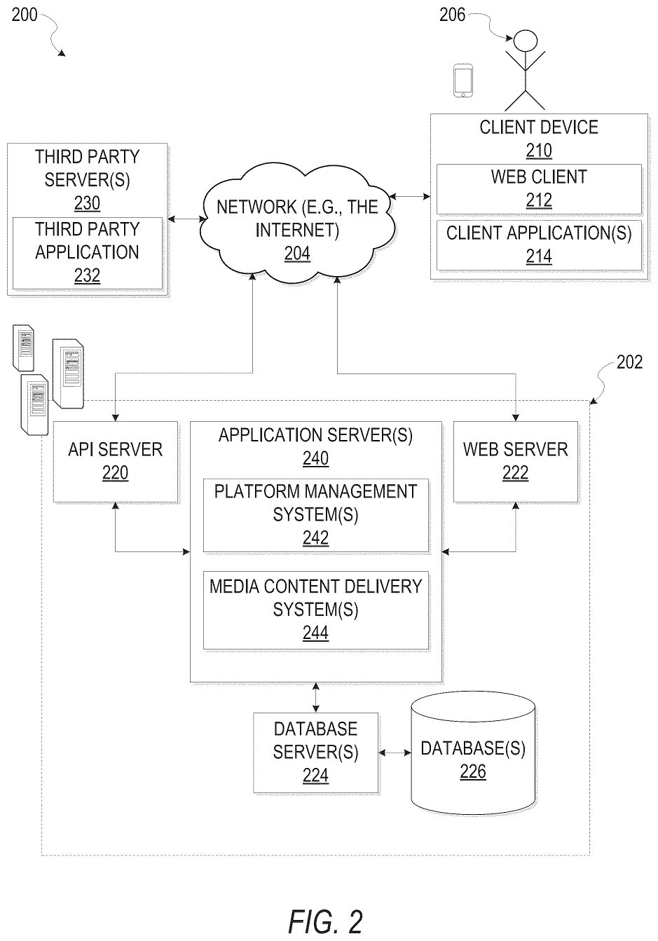

A specific example embodiment of a media content delivery method consistent with the disclosure will now be described broadly with reference to FIG. 1, after which more detailed description of example embodiments of systems, system components and operations follow with reference to FIGS. 2-7.

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

In FIG. 1, reference number 100 generally indicates a graphical user interface (GUI) displayed on a touchscreen 107 of a mobile client device in the example embodiment of a mobile smartphone 210 (see also FIG. 2) by operation of a social media application executing on the smart phone 210. In this example, the application whose GUI 100 is illustrated in FIG. 1 is a social media application providing video messaging functionality supported by a social media messaging and sharing service such as that provided by Snapchat, Inc.™ The GUI 100 in this example presents multiple sets or collections of media content items for selection by a user of the mobile phone 210, indicated in the GUI 100 as different respective “stories”. Each story (i.e., each set of user-collated media items) is viewable on the smartphone 210 in response to user selection of an associated corresponding UI element in the form of respective UI cell 104 in a vertically extending column of cells 104 displayed on the screen 107.

Each cell 104 in the GUI 100 includes a download icon in the form of a thumbnail 108 and a username corresponding to the associated set of media content items. Each set of media content items in this example consists of a respective stack of digital pictures and/or digital video clips submitted by the associated user and is viewable in automated slideshow or flipbook fashion. Here, the stack of media content associated with each cell 104 comprises a sequence of image/video items arranged by the submitting user in a particular display order, e.g. according to a storyline to be conveyed by viewing the stack in sequence.

The mobile phone application thus automatically starts loading a corresponding stack of pictures and/or video clips in response to user-selection of any one of the cells 104. In this example, the mobile phone application is configured to automatically load a first media content item in the respective stack (e.g., a first video clip or a first digital photograph, determined by a submission order dictated by the submitting user), to display corresponding media content in predetermined fashion depending on the media content (e.g., displaying a photograph or picture for a set interval, or automatically starting and completing replay of a video clip), and thereafter to display the successive picture/video clip in the stack.

A method according to one embodiment of the disclosure provides for dynamic adaptation of the format and/or configuration of media content delivery to the mobile phone 210 to provide the interactive GUI 100 and to make the associated media content available for user consumption. In this example, dynamic modification of content delivery format responsive to variations in prevailing and/or predicted resource parameters are employed with respect to a number of different mechanisms for request, delivery, and reproduction of media content. A predefined plurality of alternative delivery formats is, in this example embodiment, made available for each of (a) the download thumbnails 108, and (b) the respective media items in the stacks of the various stories. Differences between alternative delivery formats may include differences in thumbnail 108 behavior, prefetching schemes for story media, and delivery of different versions of media content files that provide the image and/or video content of the various story cells 104.

The programmatic smartphone application and/or a media content delivery system (such as the example system 202 of FIG. 2) is, in the current example, configured to make the download thumbnails 108 available as a composite pie chart-type part-circular item that visualizes download progress by progressively adding circle sectors as corresponding media items forming part of the corresponding stack are downloaded. Each thumbnail sector can display part of an image presenting the corresponding media item in the stack. The thumbnails 108 are, in this example, adaptively modifiable in two respects, namely (a) whether the pie-sectors making up the preview thumbnails 108 are composed server-side or client-side (i.e., on the mobile phone 210), and (b) whether the thumbnails 108 are displayed in a high-resolution format or in a low-resolution format. In other embodiments, further alternative content delivery formats can provide for monochrome thumbnails and/or for thumbnails that do not serve as a download counter.

Server-side composition of thumbnail components or assets places greater demand on server-side processing resources and consumes greater transmission bandwidth, but it places lesser computation demands on the mobile phone 210. Based on automated assessment of various variable resource parameters, as discussed earlier, the system 202 automatically selects one of the four available versions for the thumbnails 108 and/or thumbnail assets. It will be appreciated that the predefined plurality of alternative versions for thumbnail rendering here comprises (1) precomposed, low-resolution media content items, (2) precomposed, high-resolution items, (3) non-precomposed, low-resolution items, and (4) non-precomposed, high-resolution items.

Automated selection of a particular delivery format can comprise automatically selecting an optimal one of the predefined alternatives. Such optimization may be done with respect to one or more predefined performance metrics. In this example, automated delivery format selection is programmed to select the available option that maximizes user experience, e.g., by minimizing client-side lag, latency, or response delays. In other embodiments, optimization may be with respect to a different performance metric (e.g., including server-side performance) or to a weighted combination of performance metrics.

Returning now to the example embodiment of FIG. 1, it will be seen that if, for example, the system 202 determines (based, e.g., on historical network performance of the phone 210 and of other mobile devices over the prevailing network connection at the corresponding time of day and week) that estimated network performance for delivering media content responsive to a request is relatively poor or falls below a predefined threshold value while sufficient processing and memory resources are available on the mobile phone 210, a delivery format version for the thumbnail assets and components is automatically selected to be non-precomposed, low-resolution items. If, for example, it is additionally established or estimated that limited on-device computational resources are available for thumbnail composition, the system 202 may automatically select for delivery the pre-composed low-resolution version of each respective thumbnail 108 and/or thumbnail component. Automated selection may, in such cases, comprise automatically calculating, based on the applicable measured, estimated and/or predicted resource performance parameters, estimated client-side latency, lag, or delay for delivery and replay/presentation of the requested media content for the different available alternative delivery formats, and selecting that delivery format which has the lowest estimated value for these performance metrics.

Regarding prefetching of the media content items making up the respective stacks or stories corresponding to the respective cells 104 of the GUI 100, the available alternative delivery formats in this example include different prefetching schemes or configurations which can be employed depending on prevailing or expected network and/or device resource parameters. Considering that the user of the mobile phone 210 may select any one of the story cells 104 for viewing first, and further considering that any lag or delay between stack selection and commencement of replay is to be minimized or prevented, the method in this example provides for prioritizing download of a first number of media items in the stack of each cell 104. This is to be contrasted with sequentially pre-fetching all of the media items of one stack before downloading any media items of the next stack in the displayed list of stories. When the user then selects, say, the seventh story cell 104 in the GUI 100, the first few media items in the selected stack are immediately available for presentation (here, displaying digital images and replaying video clips), during which download of the remaining media items in the selected stack is prioritized.

This prefetching scheme is, in the current example embodiment, however, automatically modified for different requests in which different resource parameters (measured, estimated, and/or predicted) apply. For example, if prevailing or expected network performance is relatively good (e.g., having a data transmission parameter value exceeding a predefined threshold), a first few media items for each stack (e.g., the first four items for each stack) are automatically downloaded in the best resolution or quality version available for display. If, instead, prevailing or expected network performance is relatively poor (e.g., displaying below-threshold values for one or more predefined data transmission parameters), lower quality versions of the relevant media content files may initially be downloaded for the first few media items of each of the story stacks, after which higher-quality versions of the relevant media items are downloaded to replace the earlier downloaded lower-quality versions. In this example, each lower-quality file version has a lower resolution than that of the corresponding higher-quality file version. Instead, or in addition, different quality image files can have different compression ratios, in some instances using different compression protocols that vary in decompression quality.

In combination with dynamically adaptive selection of thumbnail format and dynamically adaptive selection of content prefetching scheme, the method in this example embodiment further provides for dynamically adaptive selection of media content file version or format. The description that follows details some aspects in which version optimization for video content is implemented in the example embodiment, but note that similar or analogous optimization may be performed with respect to digital images, audio, or other media content.

At least some of the media content stacks or stories for the respective cells 104 of the example GUI 100 consist of video files or items for displaying corresponding video clips on the mobile phone 210. One aspect of media content delivery adaptation for such video content may comprise making available for delivery video content at two or more different resolutions. The particular resolution for each video file is then automatically selected to minimize download and/or replay lag or latency based on measured prevailing resource performance and/or based on automatically determined expected resource performance based on relevant historical resource performance.

Instead, or in addition, the method may, in this example, provide for automated dynamically adaptive selection from differently compressed versions of the respective video content files providing the respective video items. One aspect of such compression optimization includes selecting whether to provide a requested video file in the compression format as uploaded by the submitting user, or whether to generate a differently compressed version for delivery. Resource constraints or considerations that factor into such automated version selection in this example embodiment include server-side computational resources and data transmission resources.

If, for example, a user submits a movie or video clip that is relatively poorly compressed, the system 202 has the capability of compressing the submitted video more compactly without significantly compromising eventual video playback quality. The re-compressed file version would, in such case, be significantly smaller and would therefore consume less transmission bandwidth, but re-compression of the submitted video file would demand computational resources on the media content delivery service that would otherwise be available for other purposes.

The system 202 is, in this example embodiment, configured to establish or estimate prevailing/estimated server resource availability and prevailing/estimated network resource availability, and to automatically select between the originally submitted video file and the recompressed video file for delivery to the requesting mobile phone 210. In some examples such automated selection comprises calculating which one of a number of differently compressed versions of the relevant media content file provides for optimal media consumption experience for the user, e.g., by minimizing latency or lag between stack selection and media replay on the mobile phone 210. If, for example, relatively poor network performance prevails or is expected, while sufficient server resources are available, the system 202 may automatically generate a recompressed version of the submitted video file, and deliver the recompressed version to the requesting mobile phone 210.

In some embodiments, the newly created recompressed version of the video file may be stored in a media content database, to be available for delivery in response to future requests for the corresponding video clip. Automated identification of an optimal or otherwise automatically selected delivery format for such future requests may be similar to that described above, but without factoring in server resource demands for file compression. This is because the recompressed version of the file is already available for delivery and need not be re-created. Some provide for such on-the-fly generation of alternative file versions or delivery formats (in which each different version of a media content file, apart from the originally submitted version, is created only upon first selection of that version for delivery responsive to an associated user request). Other embodiments provide for automatically generating, by default, one or more alternative file versions of each video content file upon initial submission thereof.

Various combinations of the different delivery formats for the media content accessible via the mobile phone app whose GUI 100 is shown in FIG. 1 may automatically be selected for different requests from the same phone 210 and for requests for media content delivery from different client devices, depending on the particular values for applicable variable resource parameters, as described earlier. In the example embodiment described with reference to FIG. 1, variable resource parameters or factors which are accounted for in automated optimal delivery format determination includes, but is not limited to:
historical download and/or replay performance of the mobile phone 210 when it is connected to its current data network;
historical download and/or replay performance of other mobile devices when they are connected to the current network of the mobile phone 210;
historical performance of the mobile phone 210 when it was in a substantially similar physical location. In some instances, a single value may be provided for a single defined geographical location, such as a predefined geographic region (e.g., a county, precinct, or city), a distinct establishment (e.g., a restaurant or store), a distinct event venue (e.g., a stadium, arena, or music hall), a geofence area, or a circular area within a predefined maximum radius from the current geographic position of the phone 210. In other embodiments, a compound historical performance value may be calculated based on respective historical performance values for two or more nested locations or areas (e.g., being based both on historical performance at a particular venue and on historical performance within a county in which the venue is located);
historical performance of other mobile devices when they were in a substantially similar physical location, analogous to physical location determinations discussed above;
historical performance of the mobile phone 210 at this time of day, week, month, and/or year (or, in some embodiments, at a time value corresponding to a future date at which content delivery is expected to occur);
historical performance of other mobile devices at the relevant time of day, week, month, and/or year;
more finely attuned network connection parameters, such as specific parameters or measurements of the wireless connection (e.g., current Wi-Fi channel, dBm levels, interference measurements, cellular tower identity, signal strength, recent tower migration history, etc.)
recent delta in request volume from the same network and/or from substantially the same physical location;
existing device battery life;
estimated expected future battery life attributes, calculated based on historical device utilization;
existing device contention for resources (RAM, network, CPU);
historical device contention for resources and/or historical computational performance during corresponding media reproduction operations, application configuration, time, location, etc.;
historical data usage over the current network within the current billing period, e.g., to identify the likelihood of data transfer throttling triggered by high resource utilization in the recent past;
any combination of the above-listed factors or any other factors described or mentioned herein as being relevant to automated delivery format optimization.

As will be understood from the foregoing description, the described example embodiment of media content delivery methods may thus enable a mobile device 210 or content server to “learn” adaptively, for example, that network performance for a particular venue over a corresponding interval has historically been relatively poor (e.g., as defined by predefined download speed ranges or free bandwidth), that there has been a recent spike in media content requests from the applicable physical location, and that computational resources of the requesting device are not currently unduly limited. In response to these determinations by the relevant media content server (or, in some embodiments, a corresponding application executing on the smartphone 210) in response to which, for example, highly compressed versions of requested media content files are automatically selected for delivery to the requesting phone 210. Media content delivery is thus optimized in that the relatively smaller versions of the media content files place relatively smaller demands on data transmission resources (for which there is high contention) and place relatively higher demands on on-device resources (for which there is relatively low contention).

### Example System(s)

FIG. 2, shows an example embodiment of high-level client-server-based network architecture 200 that provides for dynamically adaptive media content delivery services as disclosed herein. A networked system 202, in the example form of a social media platform system, provides server-side functionality via a network 204 (e.g., the Internet or wide area network (WAN)) to multiple mobile client devices 210. For clarity of illustration, only one mobile client device 210 is shown in FIG. 2, but many similar or analogous client devices 210 are typically connected to the system 202 at any given time. It will be appreciated that non-mobile client devices 210 may subscribe to services provided by the system 202, and that dynamic media format adaptation may, in some instances, be employed with respect to content delivery to such non-mobile client devices 210 (e.g., desktop computers). The system 202 is, in this example, configured to provide a social media service that includes media content-rich functionalities, such as video messaging and/or online video sharing.

The client device 210 can execute software for providing various functionalities associated with social media services and media content consumption. FIG. 2 illustrates, for example, a web client 212 (e.g., a browser, such as the Internet Explorer® browser developed by Microsoft® Corporation of Redmond, Washington State), and an on-device client application 214 executing on client device 210.

Different types of client devices 210 on which social media functionalities are available via the system 202 may comprise, but are not limited to, mobile phones, desktop computers, laptops, portable digital assistants (PDAs), smart phones, tablets, ultra-books, netbooks, multi-processor systems, microprocessor-based or programmable consumer electronics, game consoles, set-top boxes, or any other communication device that a user may utilize to access the networked system 202. In some embodiments, the client device 210 may comprise a display module (not shown) to display information (e.g., in the form of user interfaces). In further embodiments, the client device 210 may comprise one or more of a touch screens 107, accelerometers, gyroscopes, cameras, microphones, global positioning system (GPS) devices, and so forth. The client device 210 may be a device of a user that is used to perform a transaction involving digital items within the networked system 202. In one embodiment, the networked system 202 is configured to provide a media content delivery service that responds to requests for media content from remote mobile client devices 210.

The users 206 associated with respective client devices 210 may be a people, machines, or other means of interacting with client devices 210. In some embodiments, the user 206 is not part of the network architecture 200, but may interact with the network architecture 200 via client device 210 or another means. For example, one or more portions of network 204 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, a wireless network, a WiFi network, a WiMax network, another type of network, or a combination of two or more such networks.

Each of the client devices 210 may include one or more applications (also referred to as “apps”) such as, but not limited to, a web browser, messaging application, electronic mail (email) application, and the like. The client applications 214 can, in the example embodiment of FIG. 1, include social media apps that can execute on the device 210 and cooperate with the system 202 to submit media content requests and to optimize media content delivery, including apps that facilitate media content downloading to the device 210 (such as, for example, a Snapchat™ app). In some embodiments, a client application 214 on the client device 210 performs the described automated operations for optimizing media delivery formats. In other embodiments, such automated determinations or selection operations are performed by a content delivery server, such as application server 240 in FIG. 2. In such cases, the relevant client application 214 may be configured to gather relevant resource information from the device 210 (e.g., performance history data, current presentation on the device, current network connection information, and the like), and to communicate such information to the application server 240 for facilitating automated content delivery optimization.

In some embodiments, if the social media application is included in a given one of the client device 210, then this application is configured to locally provide the user interface and at least some of the functionalities with the application configured to communicate with the networked system 202, on an as needed basis, for data and/or processing capabilities not locally available (e.g., access to a social media platform to upload and/or download media content, etc.). Conversely, if the social media application is not included in the client device 210, the client device 210 may use its web browser to access the relevant social media site (or a variant thereof) hosted on the networked system 202.

An application program interface (API) server 220 and a web server 222 are coupled to, and provide programmatic and web interfaces respectively to, one or more application servers 240. The application servers 240 may host one or more systems for providing various functionalities, for example including a social media platform management system(s) 242 and a media content delivery system 244, each of which may comprise one or more modules or applications and each of which may be embodied as permanently configured hardware, hardware, executing software to dynamically configure one or more processor devices to perform various automated operations, firmware, or any combination thereof. The application servers 240 are, in turn, shown to be coupled to one or more database servers 224 that facilitate access to one or more information storage repositories or database(s) 226. In an example embodiment, the databases 226 are storage devices that store information to be posted on the social media platform, message data, and/or media content (e.g., digital photos, videos, and audio files). The databases 226 may also store digital item information in accordance with example embodiments.

Further, while the client-server-based network architecture 200 shown in FIG. 2 employs a client-server architecture, the present disclosure is not limited to such an architecture, and could equally well find application in a distributed, or peer-to-peer, architecture system, for example. The various platform management system(s) 242 and content delivery system(s) 244 could also be implemented as standalone software programs, which do not necessarily have networking capabilities.

The web client 212 may access the various platform management and media content delivery systems 242 and 244 via the web interface supported by the web server 222. At least some of the client application(s) 214 may comprise a programmatic client to cooperate with the system 202 to facilitate media content delivery. Additionally, a third party application 232, executing on a third party server(s) 230, is shown as having programmatic access to the networked system 202 via the programmatic interface provided by the API server 220. For example, the third party application 232, utilizing information retrieved from the networked system 202, may support one or more features or functions on a website hosted by the third party.

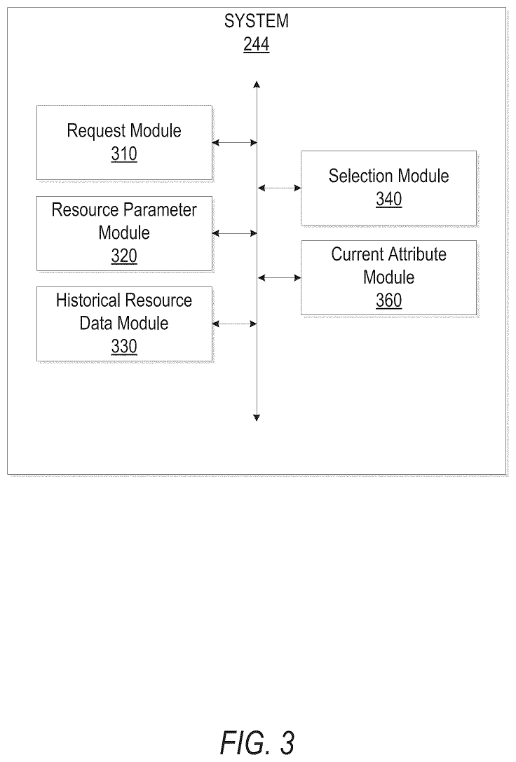

FIG. 3 is a schematic block diagram of an example embodiment of a media content delivery system 244, in accordance with an example embodiment. The system 244 comprises a number of different hardware-implemented modules configured for automated performance of associated operations, as described in greater detail elsewhere herein. The various modules may, in some embodiments, be provided by permanently configured circuit arrangements, and may, in other embodiments, be provided by software executing on one or more dynamically reconfigurable processor devices, thereby to configure the processor devices sequentially, or in parallel, to provide the respective hardware-implemented modules. In some embodiments, the system 244 may be provided by server-side components, such as in the example embodiment of FIG. 2. In other embodiments, at least part of the system 244 may be provided by the mobile client device 210 executing custom software.

The system 244 includes a request module 310 configured to receive a request for delivery of media content to a mobile client device 210. In cases where the request module 310 is a server-side component, the request module 310 may be configured to receive an electronic communication originating from the relevant mobile device 210 that indicates the particular media content which is to be delivered. In other embodiments, where request module 310 forms part of the mobile client device 210, request module 310 may be configured to receive and interpret user input on the device 210, and to communicate an electronic request message to the relevant media content delivery server.

A resource parameter module 320 is configured to perform automated determination of a respective value for each of one or more variable resource parameters applicable to deliver the requested media content to the requesting device 210 and/or to present the requested media content on the client device 210 (e.g., by reproducing relevant images, video, and audio on the device 210). The resource parameter module 320 in this example embodiment cooperates with a historical resource data module 330 and a current attribute module 360 (both of which may, in some embodiments, form part of the resource parameter module 320) in order to determine the respective applicable resource parameter values. As described elsewhere herein, the resource parameter values may be currently measurable performance parameters (e.g., signal strength, on-device resource contention, and the like), estimated resource performance based on historical performance data provided by the historical resource data module 330 (e.g., historical performance of the device 210 and/or other devices when connected to the current network and/or when located in the current geographical area), and predicted future resource performance based on historical performance data. The current attribute module 360 may establish and communicate current attributes applicable to the request for media content delivery, in order to facilitate automated estimation of the resource parameter values. Such current attributes may include, for example, the physical location of the requesting device 210, the cellular network of the device 210, and the like.

The example system 244 further includes a selection module 340 configured for automated selection from a redefined plurality of alternative delivery formats of a specific delivery format which is to apply to media content delivery responsive to the request. Such automated selection is, in this example embodiment, based, at least in part, on the previously determined applicable resource parameter values, the established current attributes, and/or the measured live resource parameters, as discussed in greater detail elsewhere herein.

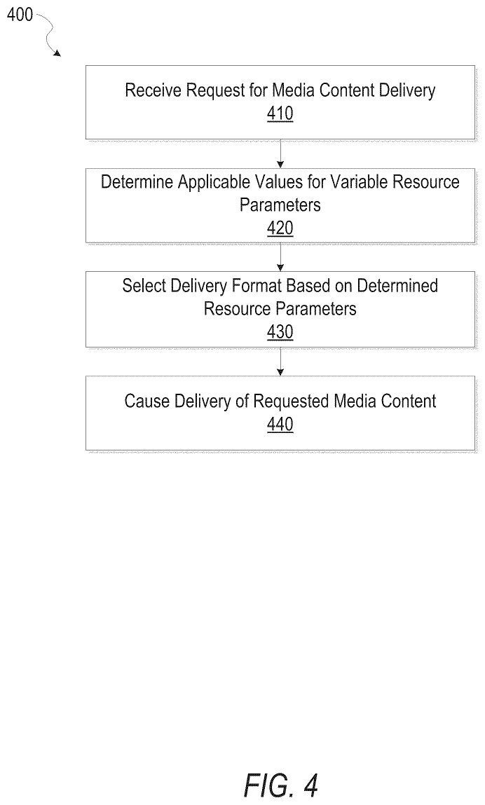

Turning now to FIG. 4, therein is shown in a high-level overview of an example embodiment of a method 400 for delivering media content according to the disclosure. The method 400 includes, at 410, receiving a request for delivery of media content to a requesting mobile client device 210 over a data transmission network 204. Delivery of the requested media content comprises transmission of the requested media content to the mobile client device 210, the media content including one or more media content files that can be processed by the mobile client device 210 to present the relevant media content on the device 210.

At 420, a respective value for each of a plurality of resource parameters applicable to delivery of the requested media content to the device 210 and to presentation of the requested media content on the device 210 is determined. At 430, a specific delivery format from a plurality of alternative delivery formats is automatically selected, e.g. by calculating an optimal one of the plurality of alternatives with respect to a predefined performance metric or combination of performance metrics.

At 440, the system 244 causes delivery of the requested media content to the requesting device 210 according to the automatically selected delivery format. As described in greater detail elsewhere, alternative delivery formats may provide, inter alia, for alternative versions of relevant media content files, for alternative delivery schemes or sequences, and/or for delivery of media content having different replay functionalities.

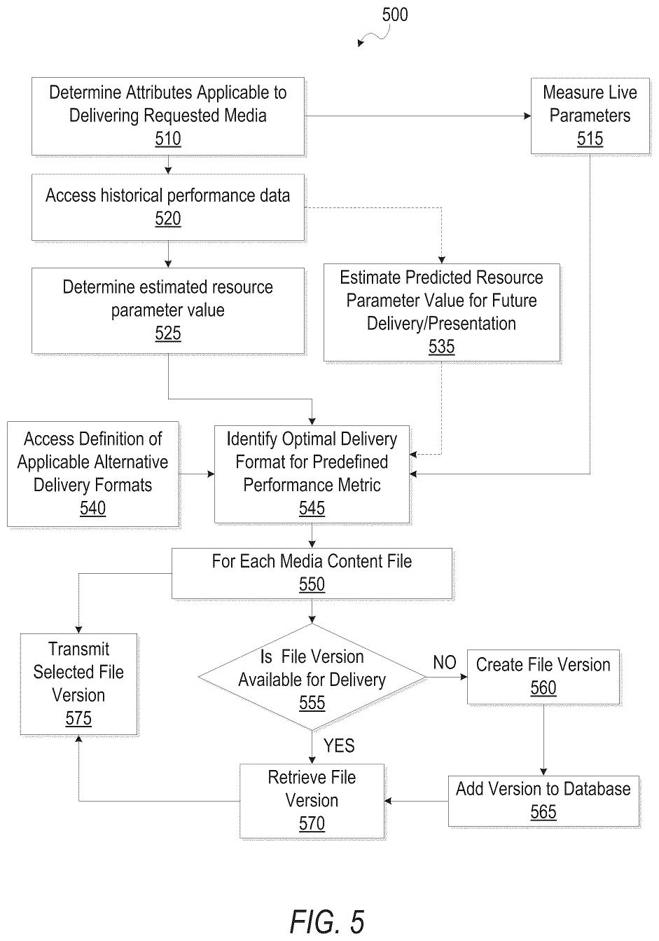

In FIG. 5, reference numeral 500 indicates a more detailed flowchart of some operations forming part of an example embodiment of a method for automated media content delivery optimization. At operation 510, the system 244 automatically determines current attributes applicable to delivering requested media content. This may include, for example, determining the current physical location, identity, and cellular network of the requesting device 210. At operation 515, one or more currently measurable resource parameters are automatically determined. Again, these may include, for example, current signal strength, current on-device contention for resources, current server capacity, applicable time values, etc.

At operation 520, historical performance data associated with the request is automatically accessed. At operation 525, estimated resource parameter values are automatically determined based, at least in part, on the established current attributes and the relevant historical performance data. For example, historical performance values of the relevant device 210 and network 204 may be determined for a corresponding time and physical location. In some embodiments, predicted resource parameter values expected to apply to future content delivery or presentation may automatically be estimated at operation 535.

At operation 545, an optimal delivery format from a relevant predefined plurality of delivery formats is identified in an automated operation. To this end, a definition of the applicable alternative delivery formats (stored, e.g., in the database(s) 226) is accessed, at 540. Identification of the optimal one of these alternatives, at operation 545, in this example embodiment comprises calculating estimated performance metrics for the different respective alternatives based on the applicable current attributes, applicable estimated resource parameter values, and the live resource performance measurements established at operation 515. As discussed elsewhere herein, the performance metric with respect to which content delivery optimization is performed may be different in different embodiments. In this example embodiment, however, the optimization metric is a minimal value for user-experienced lag or latency.

Thereafter, it is determined, at 555, for each media content file (550), whether or not a corresponding version of the media content file is available in the database(s) 226. If the applicable file version is available the file is retrieved, at 570, and is then transmitted to the client device 210, at 575.

If, however, the corresponding version of the media content file is not available in the database(s) 226, then the corresponding alternative file version is created, at operation 560, and is added to the database(s) 226, at operation 565. The creation of such an alternative file version may comprise, for example, generating a version of an image or video file at a different resolution, at a different compression ratio, or using a different compression protocol. Thereafter, the newly created file version is retrieved and transmitted, at operation 575. Operations 550 through 575 are repeated for each media content file corresponding to the requested media content, with transmission occurring according to a particular selected delivery scheme or sequence.

It is a benefit of the example embodiments that it provides for improved user experience in consuming media content on a mobile device. Optimization of delivery formats, for example, achieves relatively uniform user experiences across different times and places, promoting user loyalty and adoption of applications that are rich in media content consumption.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein. In such cases, the various described hardware modules of a system or machine to perform the disclosed operations may not at any time have all of the modules described as forming part of the system or machine. Instead, a reconfigurable computer processor (e.g., a CPU) may, at various times, be configured by execution of specific software to form different corresponding modules.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an application specific integrated circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” or reference to a processor(s) configured to perform specified operations should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. As mentioned earlier in respect to embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network 204 (e.g., the Internet) and via one or more appropriate interfaces (e.g., an application program interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 1-7 are implemented in some embodiments in the context of a machine and an associated software architecture. The sections below describe representative software architecture(s) and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things”, while yet another combination produces a server computer for use within a cloud computing architecture. Not all combinations of such software and hardware architectures are presented here as those of skill in the art can readily understand how to implement various embodiments consistent with this disclosure in different contexts from the disclosure contained herein.

### Software Architecture

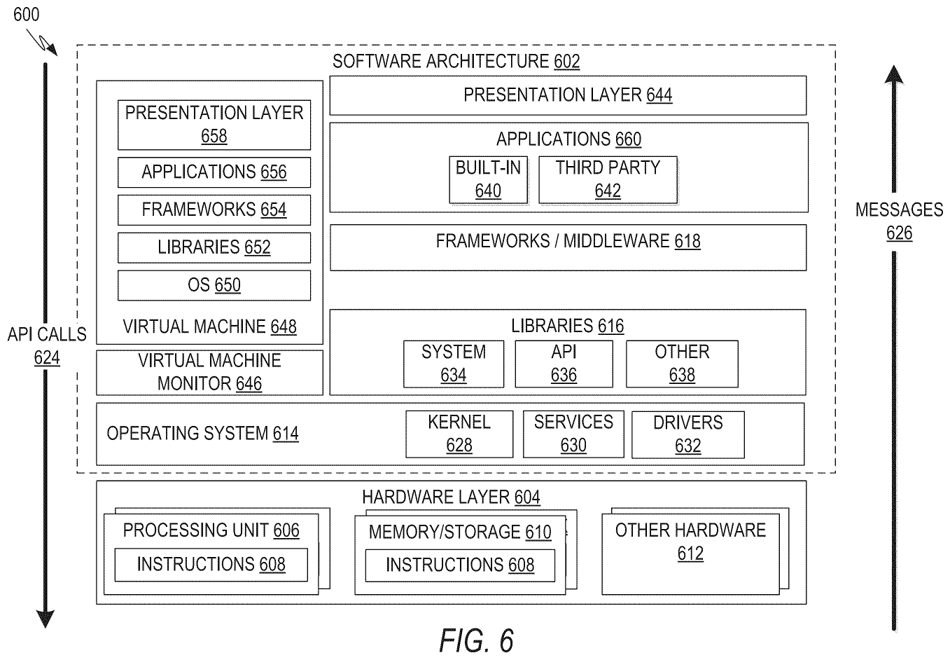

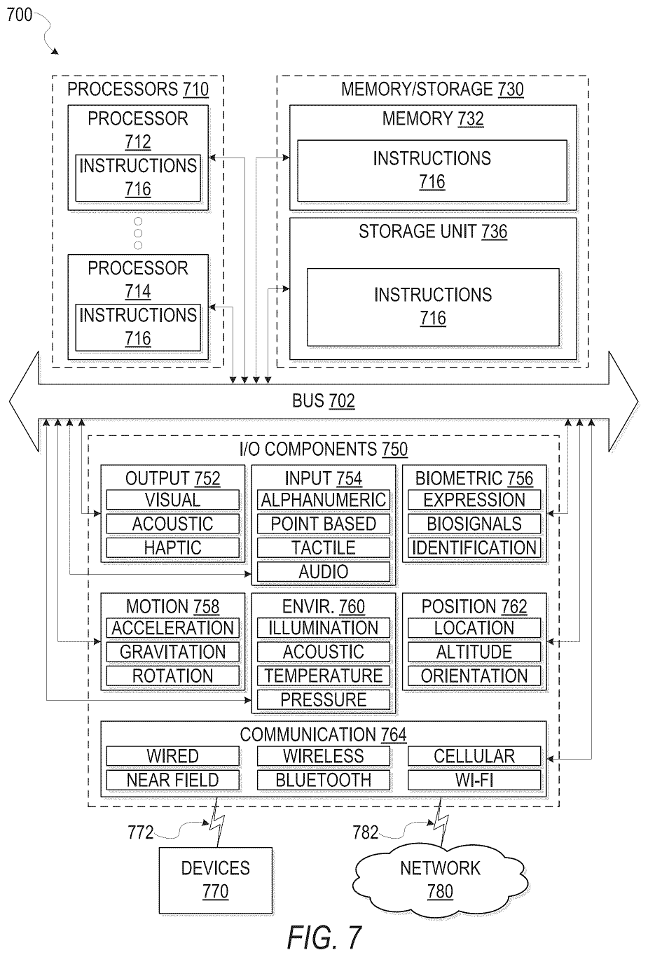

FIG. 6 is a block diagram 600 illustrating a representative software architecture 602, which may be used in conjunction with various hardware architectures herein described. FIG. 6 is merely a non-limiting example of a software architecture and it will be appreciated that many other architectures may be implemented to facilitate the functionality described herein. The software architecture 602 may be executing on hardware such as machine 700 of FIG. 7 that includes, among other things, processors 710, memory 730, and I/O components 750. A representative hardware layer 604 is illustrated and can represent, for example, the machine 700 of FIG. 7. The representative hardware layer 604 comprises one or more processing units 606 having associated executable instructions 608. Executable instructions 608 represent the executable instructions of the software architecture 602, including implementation of the methods, modules and so forth of FIGS. 1-7. Hardware layer 604 also includes memory and/or storage modules 610, which also have executable instructions 608. Hardware layer 604 may also comprise other hardware as indicated by 612 which represents any other hardware of the hardware layer 604, such as the other hardware illustrated as part of machine 700.

In the example architecture of FIG. 6, the software 602 may be conceptualized as a stack of layers where each layer provides particular functionality. For example, the software 602 may include layers such as an operating system 614, libraries 616, frameworks/middleware 618, applications 660 and presentation layer 644. Operationally, the applications 660 and/or other components within the layers may invoke application programming interface (API) calls 624 through the software stack and receive a response, returned values, and so forth illustrated as messages 626 in response to the API calls 624. The layers illustrated are representative in nature and not all software architectures have all layers. For example, some mobile or special purpose operating systems 614 may not provide a frameworks/middleware layer 618, while others may provide such a layer. Other software architectures may include additional or different layers.

The operating system 614 may manage hardware resources and provide common services. The operating system 614 may include, for example, a kernel 628, services 630, and drivers 632. The kernel 628 may act as an abstraction layer between the hardware and the other software layers. For example, the kernel 628 may be responsible for memory management, processor management (e.g., scheduling), component management, networking, security settings, and so on. The services 630 may provide other common services for the other software layers. The drivers 632 may be responsible for controlling or interfacing with the underlying hardware. For instance, the drivers 632 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 616 may provide a common infrastructure that may be utilized by the applications 660 and/or other components and/or layers. The libraries 616 typically provide functionality that allows other software modules to perform tasks in an easier fashion than to interface directly with the underlying operating system 614 functionality (e.g., kernel 628, services 630 and/or drivers 632). The libraries 616 may include system 634 libraries (e.g., C standard library) that may provide functions such as memory allocation functions, string manipulation functions, mathematic functions, and the like. In addition, the libraries 616 may include API libraries 636 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 616 may also include a wide variety of other libraries 638 to provide many other APIs to the applications 660 and other software components/modules.

The frameworks 618 (also sometimes referred to as middleware) may provide a higher-level common infrastructure that may be utilized by the applications 660 and/or other software components/modules. For example, the frameworks 618 may provide various graphic user interface (GUI) functions, high-level resource management, high-level location services, and so forth. The frameworks 618 may provide a broad spectrum of other APIs that may be utilized by the applications 660 and/or other software components/modules, some of which may be specific to a particular operating system 614 or platform.

The applications 660 includes built-in applications 640 and/or third party applications 642. Examples of representative built-in applications 640 may include, but are not limited to, a contacts application, a browser application, a book reader application, a location application, a media application, a messaging application, and/or a game application. Third party applications 642 may include any of the built in applications 640 as well as a broad assortment of other applications. In a specific example, the third party application 642 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems 614. In this example, the third party application 642 may invoke the API calls 624 provided by the mobile operating system such as operating system 614 to facilitate functionality described herein.

The applications 660 may utilize built in operating system functions (e.g., kernel 628, services 630 and/or drivers 632), libraries 616 (e.g., system 634, APIs 636, and other libraries 638), and frameworks/middleware 618 to create user interfaces to interact with users 206 of the system 202. Alternatively, or additionally, in some systems, interactions with a user 206 may occur through a presentation layer, such as presentation layer 644. In these systems, the application/module “logic” can be separated from the aspects of the application/module that interact with a user 206.

Some software architectures utilize virtual machines. In the example of FIG. 6, this is illustrated by virtual machine 648. A virtual machine 648 creates a software environment where applications/modules can execute as if they were executing on a hardware machine (such as the machine 700 of FIG. 7, for example). A virtual machine 648 is hosted by a host operating system (operating system 614 in FIG. 6) and typically, although not always, has a virtual machine monitor 646, which manages the operation of the virtual machine 648 as well as the interface with the host operating system (i.e., operating system 614). A software architecture executes within the virtual machine 648 such as an operating system 650, libraries 652, frameworks/middleware 654, applications 656 and/or presentation layer 658. These layers of software architecture executing within the virtual machine 648 can be the same as corresponding layers previously described or may be different.

### Example Machine Architecture and Machine-Readable Medium

FIG. 7 is a block diagram illustrating components of a machine 700, according to some example embodiments, able to read instructions 608 from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein may be executed. For example the instructions 716 may cause the machine 700 to execute the flow diagrams of FIGS. 4 and 5. Additionally, or alternatively, the instructions 716 may implement the respective modules of FIG. 3 and so forth. The instructions 716 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory 730, and I/O components 750, which may be configured to communicate with each other such as via a bus 702. In an example embodiment, the processors 710 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) may include, for example, processor 712 and processor 714 that may execute instructions 716. The term “processor” is intended to include a multi-core processor 710 that may comprise two or more independent processors 712, 714 (sometimes referred to as “cores”) that may execute instructions 716 contemporaneously. Although FIG. 7 shows multiple processors 712, 714, the machine 700 may include a single processor 710 with a single core, a single processor 710 with multiple cores (e.g., a multi-core process), multiple processors 710 with a single core, multiple processors 710 with multiples cores, or any combination thereof.

The memory/storage 730 may include a memory 732, such as a main memory, or other memory storage, and a storage unit 736, both accessible to the processors 710 such as via the bus 702. The storage unit 736 and memory 732 store the instructions 716, embodying any one or more of the methodologies or functions described herein. The instructions 716 may also reside, completely or partially, within the memory 732, within the storage unit 736, within at least one of the processors 710 (e.g., within the processor 710's cache memory), or any suitable combination thereof, during execution thereof by the machine 700. Accordingly, the memory 732, the storage unit 736, and the memory of processors 710 are examples of machine-readable media.

As used herein, “machine-readable medium” means a device able to store instructions 716 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)) and/or any suitable combination thereof. The term “machine-readable medium” should be taken to include a single medium or multiple media (e.g., a centralized or distributed database 226, or associated caches and servers) able to store instructions 716. The term “machine-readable medium” shall also be taken to include any medium, or combination of multiple media, that is capable of storing instructions (e.g., instructions 716) for execution by a machine (e.g., machine 700), such that the instructions 716, when executed by one or more processors of the machine 700 (e.g., processors 710), cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 750 may include a wide variety of components to receive input, provide output, produce output, transmit information, exchange information, capture measurements, and so on. The specific I/O components 750 that are included in a particular machine 700 will depend on the type of machine 700. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion and the grouping is in no way limiting. In various example embodiments, the I/O components 750 may include output components 752 and input components 754. The output components 752 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen 107 configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen 107 that provides location and/or force of touches or touch gestures, or other tactile input components), audio input components (e.g., a microphone), and the like.

In further example embodiments, the I/O components 750 may include biometric components 756, motion components 758, environmental components 760, or position components 762 among a wide array of other components. For example, the biometric components 756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 762 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via coupling 782 and coupling 772 respectively. For example, the communication components 764 may include a network interface component or other suitable device to interface with the network 780. In further examples, communication components 764 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a Universal Serial Bus (USB)).

Moreover, the communication components 764 may detect identifiers or include components operable to detect identifiers. For example, the communication components 764 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 780 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 780 or a portion of the network 780 may include a wireless or cellular network and the coupling 782 may be a Code Division Multiple Access (CDMA) connection, a Global System for Mobile communications (GSM) connection, or other type of cellular or wireless coupling. In this example, the coupling 782 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 716 may be transmitted or received over the network 780 using a transmission medium via a network interface device (e.g., a network interface component included in the communication components 764) and utilizing any one of a number of well-known transfer protocols (e.g., hypertext transfer protocol (HTTP)). Similarly, the instructions 716 may be transmitted or received using a transmission medium via the coupling 772 (e.g., a peer-to-peer coupling) to devices 770. The term “transmission medium” shall be taken to include any intangible medium that is capable of storing, encoding, or carrying instructions 716 for execution by the machine 700, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the disclosed subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving, at a server for a messaging platform, from a client device, an online request for delivery of a message collection accessible on the messaging platform, wherein the message collection comprises a plurality of messages that each comprises respective visual media content;
determining a respective value for each of one or more variable resource parameters pertaining to respective resources selected from: data transmission resources, data storage resources, and data processing resources;
in an automated operation performed at the server based at least in part on the determined values of the one or more variable resource parameters, identifying an applicable collection delivery mechanism for the message collection by selecting between a pair of alternative collection delivery mechanisms that respectively comprise:
staggered delivery, in which the respective visual media content for at least a subset of the plurality of messages is initially delivered in a preliminary format, followed after an interval by a replacement delivery of the respective visual media content in a final format, wherein delivery of the visual media content in the preliminary format is less resource intensive than delivery thereof on the final format; and
non-staggered delivery, in which the visual media content for respective messages in the message collection is initially delivered to the client device in the final format; and
causing delivery of the requested collection of messages to the client device according to the selected collection delivery mechanism.

2. The method of claim 1, wherein the preliminary format delivers visual media in lower-quality relative to the final format, such that the visual media for a particular message delivered in the preliminary format comprises a relatively lower quality version of the respective visual media, a relatively higher-quality version of the respective visual media being delivered according to the final format.

3. The method of claim 2, wherein the lower-quality version and the higher-quality version of the respective visual media content differ in image resolution, the lower-quality version having lower image resolution than that of the higher-quality version of the visual media content.

4. The method of claim 2, wherein the lower-quality version and the higher-quality version of the respective visual media content differ in compression ratio, wherein the higher-quality version displays higher decompression quality relative to that of the lower-quality version of the visual media content.

5. The method of claim 2, wherein the lower-quality version and the higher-quality version of the respective visual media content differ in both:
image resolution; and
compression ratio.

6. The method of claim 1, wherein the identifying of the applicable collection delivery mechanism and delivering of content according to the selected collection delivery mechanism forms part of a prefetching scheme pertaining to a plurality of message collections respectively selectable for replay in a graphical user interface for the messaging platform on the client device.

7. The method of claim 6, wherein the prefetching scheme, in an instance where staggered delivery is selected as the applicable collection delivery mechanism, comprises:
delivering respective visual media content for a subset of each message collection in the preliminary format;
receiving user input selecting a particular one of the plurality of message collections for replay;
responsive to the user input, commencing replay of the selected message collection; and
during replay of one or more messages forming part of said subset of the message collection, delivering visual media content for the at least a remaining portion of the message collection according to the final format.

8. The method of claim 6, wherein each message collection has a predefined replay sequence defining an order in which respective messages in that message collection are to displayed during replay, and wherein said subset of messages for which visual media content is delivered according to the prefetching scheme comprises a plurality of messages at a start of the respective replay sequence.

9. The method of claim 1, wherein determining the respective value for each of the one or more variable resource parameters comprises:
accessing historical performance data for a respective content delivery resource applicable to delivery of the collection of messages; and
determining at least one estimated performance value based on the historical performance data.

10. The method of claim 9, wherein the at least one estimated performance value comprises a predicted value of the corresponding variable resource parameter at a future time at which delivery of the collection of messages is to be performed.

11. A system comprising:
one or more computer processor devices; and
memory storing instructions that, when executed by the one or more computer processor devices, configure the one or more computer processor devices to perform operations comprising:
receiving, at a server for a messaging platform, from a client device, an online request for delivery of a message collection accessible on the messaging platform, wherein the message collection comprises a plurality of messages that each comprises respective visual media content;
determining a respective value for each of one or more variable resource parameters pertaining to respective resources selected from: data transmission resources, data storage resources, and data processing resources;
in an automated operation based at least in part on the determined values of the one or more variable resource parameters, identifying an applicable collection delivery mechanism for the message collection by selecting between a pair of alternative collection delivery mechanisms that respectively comprise:
staggered delivery, in which the respective visual media content for at least a subset of the plurality of messages is initially delivered in a preliminary format, followed after an interval by a replacement delivery of the respective visual media content in a final format, wherein delivery of the visual media content in the preliminary format is less resource intensive than delivery thereof on the final format; and
non-staggered delivery, in which the visual media content for respective messages in the message collection is initially delivered to the client device in the final format; and
causing delivery of the requested collection of messages to the client device according to the selected collection delivery mechanism.

12. The system of claim 11, wherein the instructions configure the one or more computer processor devices such that the preliminary format delivers visual media in lower-quality relative to the final format, such that the visual media for a particular message delivered in the preliminary format comprises a relatively lower quality version of the respective visual media, a relatively higher-quality version of the respective visual media being delivered according to the final format.

13. The system of claim 12, wherein the instructions configure the one or more computer processor devices such that the lower-quality version and the higher-quality version of the respective visual media content differ in image resolution, the lower-quality version having lower image resolution than that of the higher-quality version of the visual media content.

14. The system of claim 12, wherein the instructions configure the one or more computer processor devices such that the lower-quality version and the higher-quality version of the respective visual media content differ in compression ratio, wherein the higher-quality version displays higher decompression quality relative to that of the lower-quality version of the visual media content.

15. The system of claim 12, wherein the instructions configure the one or more computer processor devices such that the lower-quality version and the higher-quality version of the respective visual media content differ in both:
image resolution; and
compression ratio.

16. The system of claim 11, wherein the instructions configure the one or more computer processor devices such that the identifying of the applicable collection delivery mechanism and delivering of content according to the selected collection delivery mechanism forms part of a prefetching scheme pertaining to a plurality of message collections respectively selectable for replay in a graphical user interface for the messaging platform on the client device.

17. The system of claim 16, wherein the instructions configure the one or more computer processor devices such that the prefetching scheme, in instances where staggered delivery is selected as the applicable collection delivery mechanism, comprises:
delivering respective visual media content for a subset of each message collection in the preliminary format;
receiving user input selecting a particular one of the plurality of message collections for replay;
responsive to the user input, commencing replay of the selected message collection; and
during replay of one or more messages forming part of said subset of the message collection, delivering visual media content for the at least a remaining portion of the message collection according to the final format.

18. The system of claim 16, wherein the instructions configure the one or more computer processor devices such that each message collection has a predefined replay sequence defining an order in which respective messages in that message collection are to displayed during replay, and wherein said subset of messages for which visual media content is delivered according to the prefetching scheme comprises a plurality of messages at a start of the respective replay sequence.

19. The system of claim 11, wherein the instructions configure the one or more computer processor devices to determine the respective value for each of the one or more variable resource parameters by:
accessing historical performance data for a respective content delivery resource applicable to delivery of the collection of messages; and
determining at least one estimated performance value based on the historical performance data.

20. A non-transitory computer-readable storage medium having stored thereon instructions that, when executed by a computer, cause the computer to perform operations comprising:
receiving, at a server for a messaging platform, from a client device, an online request for delivery of a message collection accessible on the messaging platform, wherein the message collection comprises a plurality of messages that each comprises respective visual media content;
determining a respective value for each of one or more variable resource parameters pertaining to respective resources selected from: data transmission resources, data storage resources, and data processing resources;
in an automated operation performed at the server based at least in part on the determined values of the one or more variable resource parameters, identifying an applicable collection delivery mechanism for the message collection by selecting between a pair of alternative collection delivery mechanisms that respectively comprise:
staggered delivery, in which the respective visual media content for at least a subset of the plurality of messages is initially delivered in a preliminary format, followed after an interval by a replacement delivery of the respective visual media content in a final format, wherein delivery of the visual media content in the preliminary format is less resource intensive than delivery thereof on the final format; and
non-staggered delivery, in which the visual media content for respective messages in the message collection is initially delivered to the client device in the final format; and
causing delivery of the requested collection of messages to the client device according to the selected collection delivery mechanism.
